(19) United States
(12) Patent Application Publication
(10) Pub. No.: US 2006/0161484 A1
(43) Pub. Date: Jul. 20, 2006

(54) Method and system for operating an internet accessible multi-merchant universal compilation of items

(76) Inventor: Rahul Pandhe, Union City, CA (US)

Correspondence Address: Evergreen Valley Law Group, Suite 275, 2670 S. White Road, San Jose, CA, 95148, US

(21) Appl. No.: 11/037,861

(22) Filed: Jan. 18, 2005

(51) Int. Cl. G06Q 30/00

(52) U.S. Cl. 705/27; 705/26

(57) ABSTRACT

The present invention relates to a method and system for operating an internet accessible multi-merchant universal compilation of items, adding items to this compilation and purchasing items there from. The compilation if items can either be a gift registry or a shopping list. The present invention enables addition of product items from the web site of any online retailer to an existing universal compilation of items created in accordance with a preferred embodiment of the present invention through transmission of the selected product and identifying information associated with the product to the gift registry server. Such identifying information may include the name of the product, sale price of the product, and name of the manufacturer of the product. The present invention relates to an internet accessible multi-merchant universal gift registry or shopping list that has the look and feel of a catalog.

### RELATED APPLICATION DATA

The subject matter of this application is related to that disclosed in U.S. patent application Ser. No. 10/709,888 filed Jun. 3, 2004 and this document is incorporated herein by reference.

### BACKGROUND OF THE INVENTION

1. Field of the Invention

The invention relates generally to the field of internet accessible multi-merchant universal compilation of items. More particularly, this invention relates to a method for adding product items to internet accessible multi merchant universal compilation of items and purchasing or contributing towards purchase of desired product items from such compilations.

2. Description of Related Art

The Internet is an aggregation of a vast number of computers and computer networks that are connected to one another through communication links. The interconnected computers exchange information amongst one another by deploying various services, such as electronic mail, Gopher, and the World Wide Web (“WWW.”) The WWW service enables a server computer system which is either the Web server or the Web site to send information to a remote client computer system. This information is in the form of graphical web pages and the like. Once the remote client computer system receives this information, it displays the Web pages. A Uniform resource Locator (URL) serves the purpose of uniquely identifying each resource of the WWW such as a computer or web page. In order to view a specific Web page, a client computer system sends in a request specifying the URL for that Web page such as a Hyper Text Transfer Protocol (“HTTP”) request. This request is then forwarded to the Web server that supports that Web page. The web server receives the request and processes it and thereafter sends that Web page to the client computer system for viewing. Generally, when the client computer system receives that Web page, it displays the Web page with the help of a browser.

Typically, Web pages are defined through the use of Mark Up Languages such as Hyper Text Markup Language (“HTML,) which provides a protocol for display of Web pages. When a user indicates a desire to display a Web page, the browser sends a request to the server computer system to transfer to the client computer system an HTML document that defines the Web page. On receipt of the requested HTML document by the client computer system, the browser displays the Web page as defined by the HTML protocol.

The World Wide Web is especially conducive to conducting electronic commerce. In keeping with the versatility of the World Wide Web for e-commerce, methods of doing business that revolve around and utilize this versatility of the World Wide web are fairly common. Online Gift registries and online shopping list are few of the ways in which the versatility of the World Wide web is fully explored.

Now, when a couple decides to marry, or have a baby, it is common practice to set up an online gift registry at particular stores and choose certain items which they would like to receive as gifts at their wedding or baby shower. The store where the couple registers has a database containing an index of the items that the couple has selected. A common practice is to set up a bridal registry or baby registry in a single store. Typically the description of individual items in such an enumerated list of product items consists of the product's name and manufacturer, product's price information along with any discount offers that may be available with the purchase of that product and the one or more Uniform Resource Locators (URL), which define the internet addresses of the online retailers that sell the said product. The relatives and friends of the gift recipient can then gain access to this gift registry by accessing the internet site hosting this gift registry and purchase one or more of the product items listed in the registry. A gift registry system such as this is beneficial to both the gift recipient and also to the gift giver. It enables the gift recipients to express their needs and desires in clear descriptive product item lists and it allows the gift givers to purchase items that are really desired and needed by the gift recipient rather than guessing the nature and kind of gifts that would fulfill the recipient's needs and desires.

Internet accessible universal gift Registries are an improvement over traditional single-store gift registries because they allow registrants to have a wider choice and help them select products from different online retailers and not just one single retailer as is the case in traditional online gift registries. However, the problem with internet accessible universal gift registries is that they are not universal in the real sense of the word since they are restricted to online retailers with whom the gift registry administrator has entered into an agreement. Thus, even universal gift registries suffer from the same drawback that single store gift registries do in terms of not being extensible to any and all online merchants.

Another example of a categorized product items list is the online shopping list service provided by internet based online retailers or internet based independent third party shopping list providers. An internet based shopping list system is designed to capture the needs and desires of many online shoppers by enabling such shoppers to create online shopping lists that can be easily accessed and used to store all those items that the user envisages purchasing in the near future.

Yet another related art example that uses categorized product item lists is the online wish list service provided by internet based online retailers or internet based independent third party wish list service providers. A typical internet based wish list system is designed to capture the needs and desires of internet shoppers by enabling such shoppers to create one or more lists of product items that they would be interested in purchasing at some future time. To use such a wish list system, a shopper typically creates a wish list account at the internet site operated by an online store or at a third party wish list service provider. After creating a wish list account, whenever this shopper comes across a product item at any online store that he or she would like to purchase at some future date, the shopper can add the pertinent details about such product items to the product item wish list associated with his or her wish list account. The product details typically consist of information such as the product description, its selling price, the manufacturer and brand name of the product, the name and Uniform Resource Locator of the online stores selling the product, special offers that may be available with the purchase of the desired product, etc. Moreover, certain online stores may also choose to offer their own store specific wish list service. In such a store specific wish list service, the shoppers after creating a wish list account can select product items from the online store that they would like to purchase at a future date and add the details of the selected product items to their wish list which is maintained by the online store. Typically, such online stores that offer wish list services provide convenient usability features on the store's website such as a graphical button or an internet hyperlink or such other means to enable shoppers to conveniently specify the product items that they would like to add to their wish list. In addition, some online stores that have business relationships with an independent third party wish list service provider can choose to provide similar convenient graphical features or internet hyperlinks on their websites thereby enabling shoppers to directly add descriptions of product items available at the online store to the their wish list hosted and maintained by the said independent third party wish list service provider.

As elucidated earlier, the prior art methods of creating product item lists for use in gift registries and in personal wish lists have inherent limitations and drawbacks. Gift registry services and wish list services that are offered by online retailers, either directly or through third party independent service providers, limit the shopper's choice of product items to only the set of product items that are sold by the online retailer offering the service or to a small group of online retailers who may have come together to provide a common gift registry or wish list service.

Furthermore, in order to improve usability of the gift registry or wish list service offered by the online store, such stores often have to provide one or more graphical interfaces and internet hyperlinks on their internet site to enable shoppers to conveniently select the products that they would like to add to the product item list in their gift registry or wish list. While such graphical interfaces and internet hyperlinks assist the shoppers in adding the desired product item lists to their gift registry or wish list, they tend to take up premium display area on the online store's internet web site and thus restrict the number of distinct gift registry or wish list service providers that the online store can support. In addition, online stores that provide such gift registry or wish list services, either directly or through a third party service providers, incur additional information technology related design, engineering and maintenance costs in order to provide integrated support for such services from the store's web site.

Furthermore, shoppers at online stores that do not provide adequate support for creating and adding product items to gift registries or wish lists, have to typically open an account with an independent gift registry service provider or wish list service provider and then manually create the product item list by individually adding the name and pertinent details of the desired product items into this list. This is a often a difficult and error prone proposition because shoppers would often leave out certain critical pieces of information required to identify a particular product, such as the product's brand name, the internet address of the online store selling that product, any special offers that might be available with that product etc.

As evident from the prior art examples described above, there appears to be a distinct need to provide online shoppers with an easy and convenient method of creating and operating an internet accessible multi merchant universal compilation of items such as gift registry or shopping list for adding desired product items to universal compilation of items. Such universal product item compilations overcome the limitation of traditional gift registries and wish lists that limit shoppers' choice to product items available only at a particular online store or a group of online stores by enabling online shoppers to select product items available at any of the large number of online stores on the internet. Similarly, when universal product item compilations are used in online gift registries, they enable gift registrants to select product items from any of the numerous online stores on the internet and add the desired product item to the product item list compilations associated with their compilations.

The object of the present invention is to address the limitations of the prior art examples described above and to fulfill the need for an easy and convenient method of creating and operating an internet accessible multi merchant universal compilation of items for adding desired product items to universal product item compilations that leverage the universality of the internet.

Advantageously, the present invention overcomes the limitations of conventional online gift registries and online wish list services that restrict a shopper's choice of product items to only those product items that are available in a particular online store or in a small group of closely linked online stores that may come together to provide the gift registry or wish list service.

### SUMMARY OF THE INVENTION

The present invention relates to a method and system for operating an internet accessible multi-merchant universal compilation of items, adding items to this compilation and purchasing items there from. The compilation of items can either be a gift registry or a shopping list. The present invention enables addition of product items from the web site of any online retailer to an existing universal compilation of items created in accordance with a preferred embodiment of the present invention through transmission of the selected product and identifying information associated with the product to the central gift registry server. Such identifying information may include the name of the product, sale price of the product, and name of the manufacturer of the product.

The present invention relates to a method and system for operating an internet accessible multi-merchant universal compilation of items, adding items to this compilation and purchasing items there from in a collaborative manner with friends or family.

In a preferred embodiment of the present invention, in response to a single action being performed, an online shopper can select a desired product item from any online retailer's web site and add the selected product item to an internet accessible multi merchant universal compilation of items associated with his or her name.

It is therefore an object of the present invention to enable a method of operating an internet accessible multi merchant universal compilation of items, and adding product items from the web site of any online retailer to the compilation.

It is therefore an object of the present invention to enable a method of adding product items from the web site of any online retailer and add it to an internet accessible multi-merchant compilation of items.

It is another object of the present invention to not restrict addition of product items from only those web sites of online retailers that have an agreement with the gift registry provider but rather to extend it to any online retailer.

It is yet another object of the invention to provide a method and a system for coupon matching so that purchasers of gifts can reap the benefits of coupons offered by different vendors, directly or indirectly through other end-users of such a service, such coupons being stored at the gift registry server.

Yet another object of the present invention is to provide coupon matching based on coupons stored by other service users and or/coupons offered directly to GiftWisdom by the various merchants.

Another object of the present invention is to provide a method and system for allowing shoppers to contribute collaboratively towards the purchasing of product items by cash pooling for the purchase of expensive items.

Yet another object of the present invention is to provide a method and system for allowing users to access and use the same online compilation to facilitate collaborative shopping.

Another object of the present invention is to provide a method and system for facilitating merchants to target users with customized ads.

It is therefore an advantage of the present invention to enable a method of adding product items from the web site of any online retailer and add it to an internet accessible multi-merchant gift registry.

It is another advantage of the present invention to not restrict addition of product items from only those web sites of online retailers that have an agreement with the gift registry provider but rather to extend it to any online retailer.

It is yet another advantage of the invention to provide a method and system for multi-merchant coupon matching so that purchasers of gifts can reap the benefits of coupons offered by the different vendors directly or indirectly though other end-users of such a service, such coupons being stored at the gift registry server.

Yet another advantage of the present invention is to provide coupon matching based on coupons stored by other service users and or/coupons offered directly to GiftWisdom by the various merchants.

Another advantage of the present invention is to provide a method for allowing shoppers to contribute collaboratively towards the purchasing of product items by cash pooling for the purchase of an expensive item.

Yet another advantage of the present invention is to provide a method and system for allowing users to access and use the same online compilation to facilitate collaborative shopping.

Another advantage of the present invention is to provide a method and system for facilitating merchants to target users with customized ads.

The foregoing and other objects, advantages and features of the present invention will be apparent from the following detailed description of the preferred embodiment which makes reference to the several figures of the drawing.

### BRIEF DESCRIPTION OF THE DRAWINGS

FIG. 1 is a flow chart illustrating the sequence of steps that a particular gift registry user undertakes to create a gift registry as embodied in the present invention.

FIG. 2 is a flow diagram illustrating the sequence of steps that a gift registry user undertakes to download and install the software that enables users to add product items from the web site of any online retailer.

FIG. 3 is a flow chart illustrating the sequence of steps that a gift registry user undertakes to add gifts to the gift registry.

FIG. 4 is a flow chart illustrating the sequence of steps that enable a gift registry user to contribute towards the purchasing of product items listed in the gift registry.

FIG. 5 is a flow chart illustrating the sequence of events that a gift registry user undertakes to administer private pools.

### DETAILED DESCRIPTION OF THE INVENTION

In a preferred embodiment of the present invention, a gift registry model has been described. However, it will be clear to those of ordinary skill in the art that the same model is easily adaptable to any and all internet accessible multi-merchant universal compilations of items.

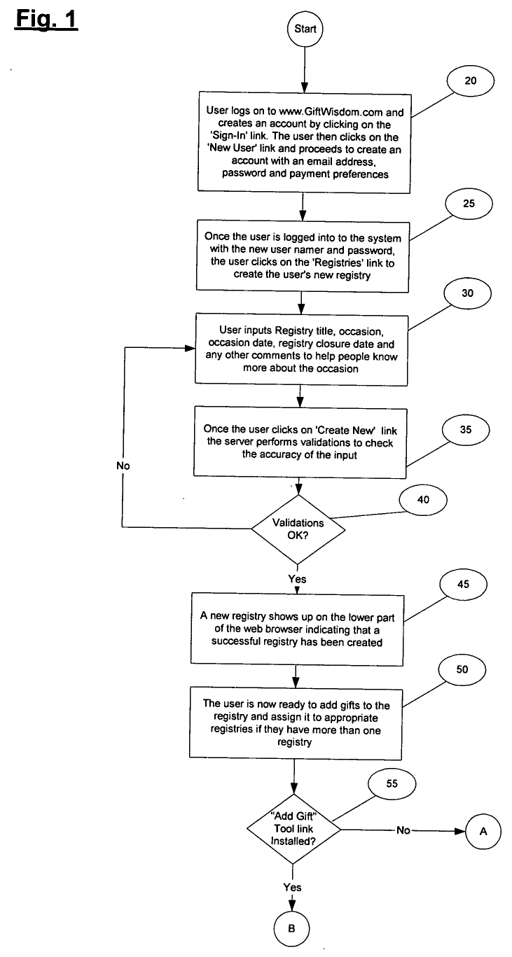

FIG. 1 is a flow chart illustrating the sequence of steps that a particular gift registry user undertakes to create a gift registry as embodied in the present invention. As shown in the figure, in order to set up a gift registry account, the user logs on to a gift registry server. In a preferred embodiment of the present invention the user logs on to www.giftwisdom.com and creates an account by clicking on the “Sign-In” link. The user then clicks on the “New User” link and proceeds to create an account with an email address, password and payment preferences as shown in step 20. Once the user is logged into the system with the new user name and password, the user may click on the “Registries” link to create a new registry as shown in step 25. In step 30, the user inputs registry title, occasion, date of occasion, registry closure date and any other comments to help people know more about the occasion for which the registry is being created. In step 35, once the user clicks on “create new” link the server performs validation check to ensure that the information input is accurate. If the validation is accurate (step 40) a new registry is created and it shows up on the lower part of the web browser indicating that a registry has been created successfully as shown in step 45. If the validations are not ok, the user will be requested to input the registry title and other information once again and an attempt will be made again to create a registry. Once a registry has been created, the user may now start the process of adding product items to the registry as shown in step 50 and may assign the product items to different registries in case the user has created multiple registries (step 50.) Prior to adding gifts to the registry however, the user will need to download the software module that will facilitate addition of product items from any online retailer to the gift registry. In a preferred embodiment of the present invention, the user will download and install the software by clicking on the “Add Gift” tool link (step 55.) After the software has been installed, the user is ready to start adding product items to the registry.

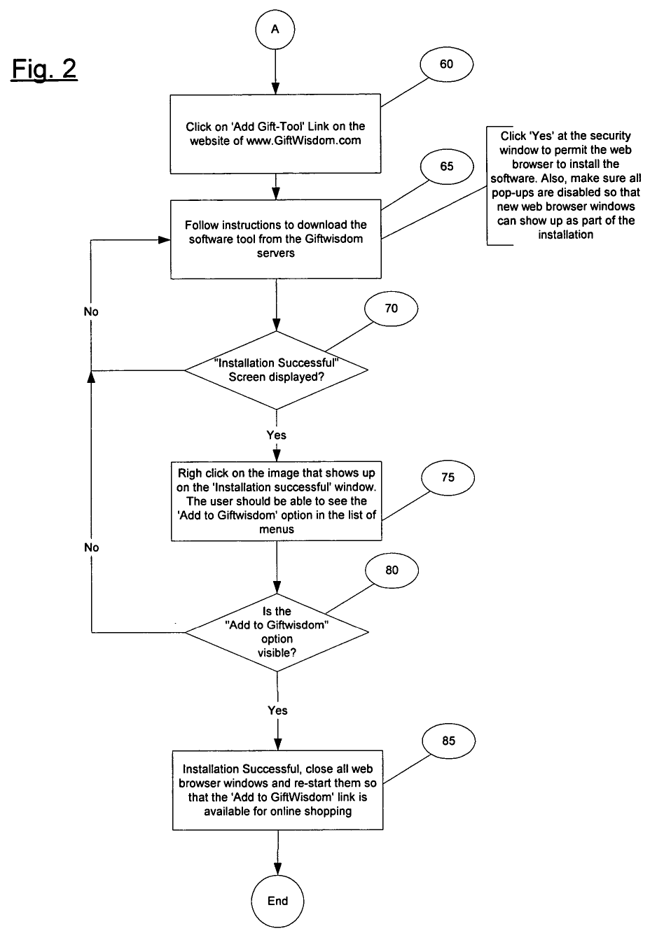

FIG. 2 is a flow diagram illustrating the sequence of steps that a gift registry user undertakes to download and install the software that enables users to add product items from the web site of any online retailer. As shown in FIG. 1, a gift registry user first creates a gift registry. In a preferred embodiment of the present invention, the gift registry user then clicks on “Add Gift-tool” link as shown in step 60. Thereafter the user follows instructions to download the software tool from the GiftWisdom servers as shown in step 65. Once the “Installation Successful” screen is displayed (step 70), the user may right click on the image that shows up on the window displaying the “Add to GiftWisdom” option in the list of menus (step 75). If the “Add to GiftWisdom” option is visible (step 80) it signifies that installation has been successful and at this stage the user may close all web browser windows and restart them so that the “Add to GiftWisdom” link is available for online shopping as shown is step 85.

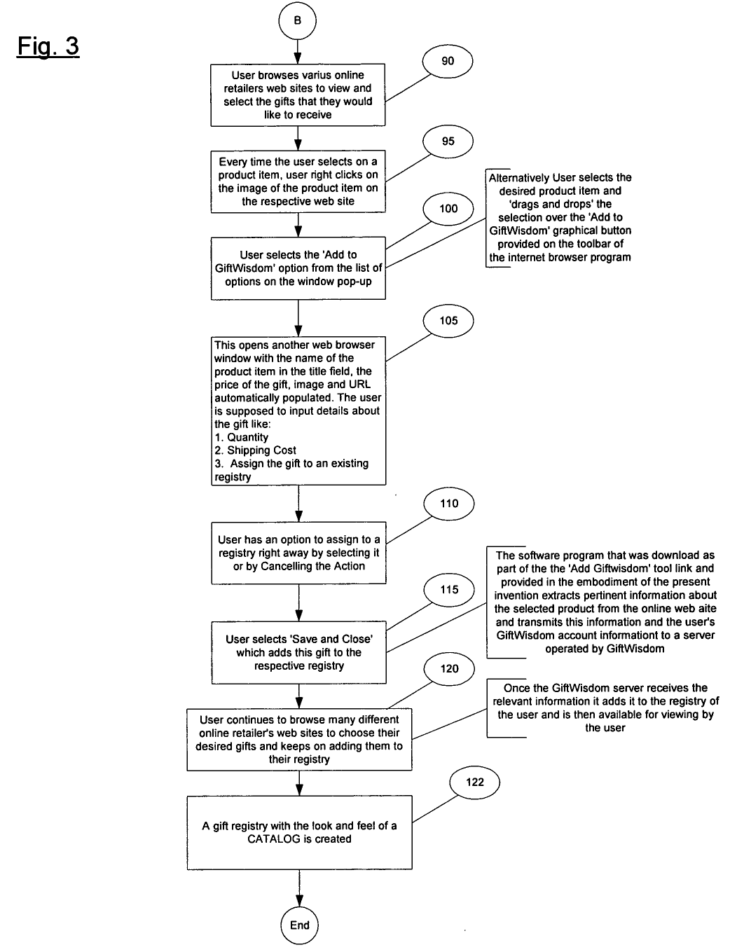

FIG. 3 is a flow chart illustrating the sequence of steps that a gift registry user undertakes to add gifts to the internet accessible multi merchant universal gift registry. In step 90, the gift registry user browses various online retailers' web sites to view and select the gifts that they would like to receive. Every time the user selects a product item that he or she would like to receive as a gift, the user right clicks on the image of the product item on the respective web site as shown in step 95. In accordance with a preferred embodiment of the present invention, the user then selects the “Add to GiftWisdom” option from the list of options on the window pop up as shown in step 100. In step 105, another web browser window opens up with certain identifying indicia unique to the product item such as the name of the product item in the title field, the price of the gift and image and URL of the gift item automatically populated. At this point, the user needs to enter additional information such as the quantity, shipping cost and whether or not the user wishes to assign the gift to an existing registry (step 105.) Now the user has an option to either assign the selected product item to a registry right away or cancel the action (step 110). The user then selects “save and close” option which in turn adds the selected product item or gift to the gift registry as shown in step 115. In step 120, the user continues to browse more online retailers' web sites and add product items to their registry thus creating the look and feel of an online catalog to the gift registry (step 122.)

In a preferred embodiment of the present invention, the gift registry or the multi merchant universal compilations of items can be used and accessed by more than one user so as to create a collaborative shopping list. This in turn facilitates the users or purchasers to have a collaborative shopping experience. According to a preferred embodiment of the present invention, more than one user can access the same gift registry or compilation, which allows the users to create a centralized shopping list which is accessible to all related users and affords a unique and efficient shopping experience whereby the users can add items, compare items added by other users and shop wisely.

In a preferred embodiment of the present invention, purchasers of gifts can avail the benefits of coupon matching directly or indirectly through end users of such a service, such coupons beings stored at the gift registry server. In a preferred embodiment of the present invention multi-merchant coupon matching is available to purchasers based on coupons stored by other service users and or/coupons offered to administrators of the gift registry server such as GiftWisdom directly by the various merchants. Thus, the present invention provides an easy and convenient method and system for purchasers to access and use all possible multi-merchant gift coupons available to them instead of having to search for coupons all over the Internet. In addition, the present invention has the advantage of making available to purchasers or end users such coupons that may not be available to the general public yet but may have been offered by specific merchants only to the administrator of the gift registry such as GiftWisdom.

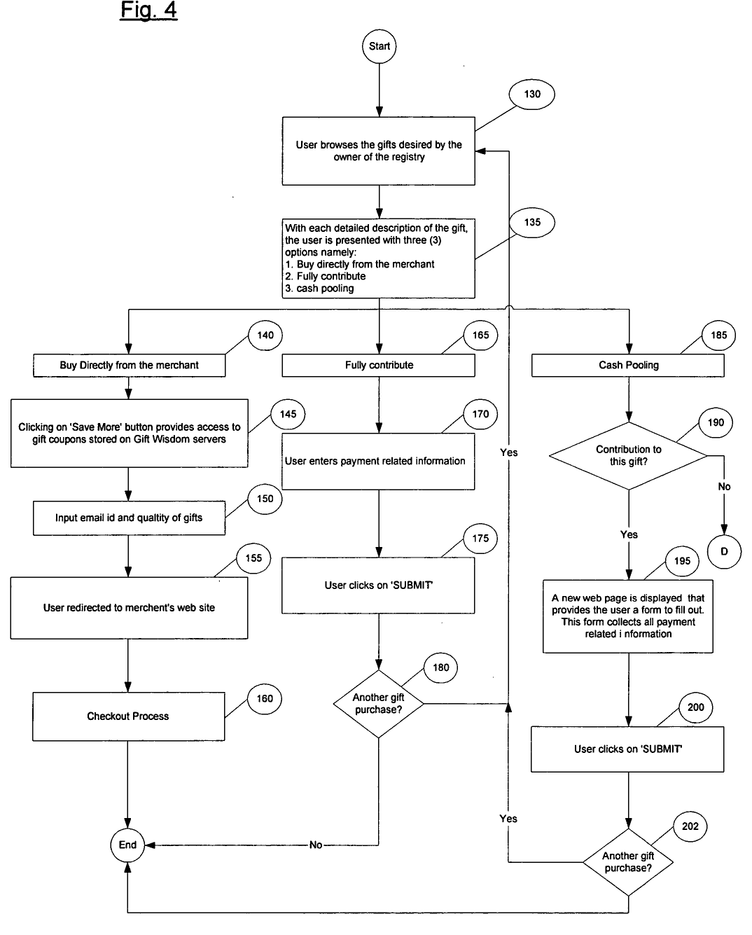

FIG. 4 is a flow chart illustrating the sequence of steps that enable a gift registry user (who wishes to purchase gifts from the registry) to contribute towards the purchasing of product items listed in the gift registry. The user/purchaser accesses the gift registry by browsing the gifts desired by the owner of the registry (step 130.) With each detailed description of the product item or gift, the user is presented with three options, namely, buy directly from merchant, fully contribute or cash pooling as shown in step 135. In accordance with a preferred embodiment of the present invention, if the user chooses to buy directly from merchant as shown in step 140, the user may also click on “Save More” option to gain access to gift coupons stored on Gift Wisdom servers (step 145.) In step 150, a new web browser window pops up that requires the user to input their email id and quantity of gifts that the user wishes to purchase. In step 155, the user is redirected to the merchant's web site, where he may complete the checkout process as shown in step 160.

In accordance with a preferred embodiment of the present invention, if the user chooses the option to fully contribute as shown in step 165, a new web page is displayed. This web page provides the user with a form to fill out. This form spells out all required payment related information such as billing information for credit card, name on credit card, credit card number, and all other information user id (step 170.) Once all the information is submitted, the user id is validated and the credit card charged for the amount entered (step 175.) At this stage the user can either go back to the original screen and exit from the browser or select another gift to purchase.

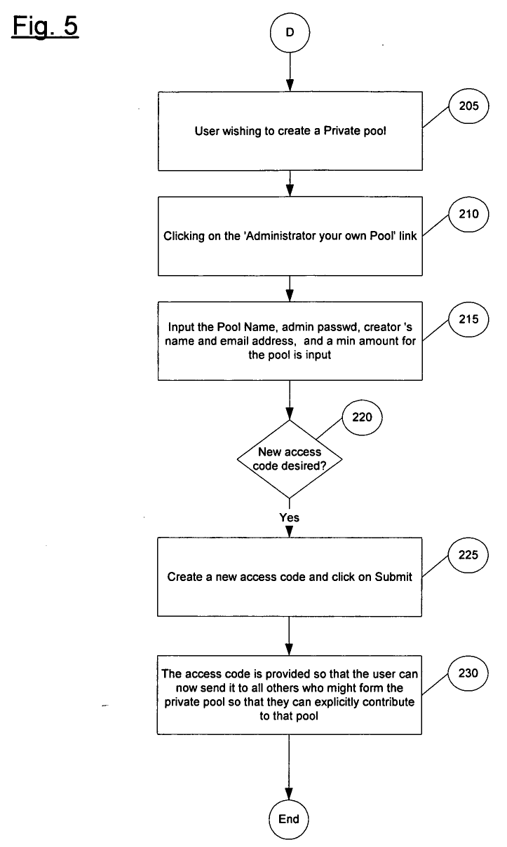

In accordance with a preferred embodiment of the present invention, if the user chooses the option to partially contribute as shown in step 185, a new web page is displayed. This web page provides the user with a form to fill out. This form spells out all info required that relates to billing information for credit card, name on credit card, credit card number, and all other information user id (step 190.) Once all the information is submitted, the user id is validated and the credit card charged for the amount entered (step 195.) At this stage the user can either go back to the original screen and exit from the browser or select another gift to purchase (step 200.) If the user wishes to contribute to the general pool, the sequence of steps that follow then is elucidated in the following description of FIG. 5.

In a preferred embodiment of the present invention, as an alternative to entering credit card to make a payment, a user with a paypal account (a person to person payment enabling service offered by PayPal.com) can make payments using Paypal service. With this mode of payment, the gift receiver gets the payment directly into their paypal account. Gift registry servers such as GiftWisdom are able to facilitate such direct contribution by integrating PayPal service for such cash gift exchange. In this manner, the gift receiver stands to benefit by getting the entire contribution without having to pay fees for credit card transactions.

FIG. 5 is a flow chart illustrating the sequence of events that a gift registry user undertakes to administer private pools. In a preferred embodiment of the present invention, private pooling is facilitated whereby more than one user can collectively contribute towards the purchase of a single expensive item. In step 205, the user decides to create a private pool so that a specific group of users can contribute together to buy an expensive gift. In accordance with a preferred embodiment of the present invention, the user clicks on “administer your own pool” link (step 210) and inputs pertinent information such as pool name, admin password, creator's name and email address, and a minimum amount for the pool (step 215.) If new access is desired (step 220) the user can create a new access code and hit “submit” button (step 225) which then creates the access code. This access code can then be sent to all others who might form the private pool and who can now explicitly contribute to that pool (step 230.)

In accordance with yet another embodiment of the invention, the internet accessible multi-merchant universal compilation of items and information related thereto such as the items selected and added to the compilation and the amount of cash that has been pooled towards purchase of a particular item is made available to individual merchants. Based on this information individual merchants may create customized advertisements and target specific users accordingly. The information related to items that are of interest to users is valuable to merchants because this shows actual interest on the part of the user to purchase those items sometime in the near future. In addition, information such as the amount of cash pooled for a particular item demonstrates more than mere interest in purchasing the item. It demonstrates a financial step taken by the users towards purchasing a particular item. Using this information, merchants can customize advertisements and target specific purchasers who have cash set aside for purchase of specific items.

Although the present invention has been particularly shown and described above with reference to specific embodiments, it is anticipated that alterations and modifications thereof will no doubt become apparent to those skilled in the art. It is therefore intended that the following claims be interpreted as covering all such alterations and modifications as fall within the true spirit and scope of the invention.

1. A method of adding an item to an internet accessible multi-merchant universal compilation of items, the method comprising:
displaying information identifying the item on an online retailer's web site, under control of a client system;
selecting the item, under control of a client system;
sending a request to add the item to the compilation in response to only a single action being performed;
processing the request by extracting identifying indicia unique to the item; and
adding the item and the identifying indicia to the compilation.

2. A method of claim 1, wherein said compilation is a gift registry.

3. A method of claim 1, wherein said compilation is a shopping list.

4. A method of adding an item to an internet accessible universal gift registry, the method comprising:
displaying information identifying the item on an online retailer's web site, under control of a client system;
selecting the item, under control of a client system;
sending a request to add the item to the gift registry in response to only a single action being performed;
processing the request by extracting identifying indicia unique to the item; and
adding the item and the identifying indicia to the gift registry.

5. A method according to claim 4, wherein said identifying indicia comprise of a description of the item, price, and a Uniform Resource Locator (URL) of the photographic image of the item.

6. A method according to claim 4, wherein adding the item to the gift registry creates an online catalog of items in the registry.

7. A method according to claim 4, further comprising the step of purchasing the item from the gift registry.

8. A method according to claim 7, wherein the purchasing can be done either in full or in part.

9. A method according to claim 8, wherein purchasing in full means paying the full price of the product item.

10. A method according to claim 8, wherein purchasing in part means making a partial contribution towards purchasing of the product item.

11. A method of providing gift coupons for use while using an internet accessible multi-merchant universal gift registry, wherein said method comprises the steps of:
storing merchant-specific gift coupons at the gift registry server, under control of web server;
and retrieving said gift coupons in response to a request for accessing gift coupons.

12. A method of collaboratively accessing an internet accessible multi merchant universal compilation of items, wherein said method comprises the steps of:
more than one user accessing the compilation of items, and
adding items to the compilation using the method of claim 1.

13. A method of collaboratively purchasing an item from an internet accessible multi merchant universal compilation, wherein said method further comprises the step of collaboratively contributing towards purchase of items from the compilation.

14. A method of facilitating merchants to provide customized ads for users based on information stored in the compilation of items.

15. A method of claim 14, wherein said information is specific to the items such as identifying indicia.

16. A method according to claim 14, wherein said information is amount of cash pooled towards purchase of items.

17. A method for facilitating a group of users to contribute towards a specific item for a specific individual, such item being identified as being available only to specific contributions.

18. A system of adding an item to an internet accessible multi-merchant universal compilation of items, the system comprising:
a display component to display information identifying the item on an online retailer's web site, under control of a client system;
selecting the item, under control of a client system;
a transfer component to send a request to add the item to the gift registry in response to only a single action being performed;
a processing component to process the request by extracting identifying indicia unique to the item; and
adding the item and the identifying indicia to the gift registry.

19. A system according to claim 18, wherein the identifying indicia comprises of a description of the item, price, and a Uniform Resource Locator (URL) of the photographic image of the item.

20. A system according to claim 19, wherein gift coupons can be stored under control of server and retrieved for purchasing of the product item.

21. A system according to claim 19, wherein adding the item to the internet accessible multi merchant universal compilation of items creates an online catalog of items.

22. A system according to claim 19, further comprises the option of purchasing the item from the compilation of items.

23. A system according to claim 22, wherein the purchasing can be done either in full or in part.

24. A system according to claim 23, wherein purchasing in full means paying the full price of the product.

25. A system according to claim 23, wherein purchasing in part means making a partial contribution towards purchasing.

26. A system of facilitating merchants to provide customized ads for users based on information stored in the compilation of items.

27. A system according to claim 26, wherein said information is specific to the items such as identifying indicia.

28. A system according to claim 26, wherein said information is amount of cash pooled towards purchase of items.
